(19) United States
(12) Patent Application Publication
(10) Pub. No.: US 2021/0295228 A1
(43) Pub. Date: Sep. 23, 2021

(54) INFORMATION PROCESSING METHOD, INFORMATION PROCESSING APPARATUS, AND NON-TRANSITORY STORAGE MEDIUM

(71) Applicant: TOYOTA JIDOSHA KABUSHIKI KAISHA, Toyota-shi (JP)

(72) Inventors: Yoshiyasu TAKEZAWA, Okazaki-shi (JP); Hirotaka TODAKA, Toyota-city (JP); Takao KIGUCHI, Nagoya-city (JP); Chieko SAWADA, Nagoya-shi (JP); Yosuke TOKUDA, Toyota-shi (JP); Ayaka KAGAMI, Inazawa-shi (JP); Natsuki SUGIYAMA, Nisshin-shi (JP); Takuzo HIRANO, Nagoya-shi (JP); Taichi AMAKASU, Toyota-shi (JP); Seiei HIBINO, Nagakute-shi (JP); Hiroshi KAWAKAMI, Nisshin-shi (JP)

(73) Assignee: TOYOTA JIDOSHA KABUSHIKI KAISHA, Toyota-shi (JP)

(21) Appl. No.: 17/198,589

(22) Filed: Mar. 11, 2021

(30) Foreign Application Priority Data
Mar. 17, 2020 (JP) 2020-046676

(51) Int. Cl. G06Q 10/06; G06Q 50/02; G06Q 50/28

(52) U.S. Cl. CPC G06Q 10/06315; G06Q 50/02; H04L 67/12; G06Q 10/06311; G06Q 50/28

(57) ABSTRACT

The present disclosure makes it possible to ship a shipping object at a right time in response to a demand. An information processing apparatus transmits demand information including a quantity demanded and a shipping deadline for an agricultural and marine product as a shipping object and shipping support information including information indicating shipping equipment that is capable of being provided in regard to shipping of the shipping object to a supplier, acquires information indicating shipping equipment that is desired to be provided and information indicating a carry-in place and a carry-in time for the shipping equipment desired to be provided from a supplier that performs shipping object supply appropriate to the demand information, and transmits an instruction to transport, by a vehicle, the shipping equipment desired to be provided in accordance with the information indicating the carry-in place and the carry-in time to a manager of the vehicle.

### CROSS REFERENCE TO THE RELATED APPLICATION

This application claims the benefit of Japanese Patent Application No. 2020-046676, filed on Mar. 17, 2020, which is hereby incorporated by reference herein in its entirety.

### BACKGROUND

### Technical Field

The present disclosure relates to an information processing method, an information processing apparatus, and a non-transitory storage medium.

### Description of the Related Art

There has been available an article supply and demand management support system which keeps articles collected from article supply sources dispersed over an unspecified number of districts at collection places in the respective districts, knows, in a centralized manner, collection places for article-packed freight containers and the quantity of articles, finds optimal conditions for transport of articles from a collection place to a demand place on receiving a demand for articles from the demand place, and transports the articles from the collection place to the demand place (see, for example, Patent document 1).

### CITATION LIST

### Patent Document

[Patent document 1] Japanese Patent Laid-Open No. 2001-233409

### SUMMARY

One or more aspects of the present disclosure are directed to provide an information processing method, an information processing apparatus, and a non-transitory storage medium capable of shipping a shipping object at a right time in response to a demand.

One aspect of the present disclosure may be an information processing method. The information processing method may include transmitting demand information including a quantity demanded and a shipping deadline for an agricultural and marine product as a shipping object and shipping support information including information indicating shipping equipment that is capable of being provided in regard to shipping of the shipping object to a supplier, acquiring information indicating shipping equipment that is desired to be provided and information indicating a carry-in place and a carry-in time for the shipping equipment desired to be provided from a supplier that performs shipping object supply appropriate to the demand information, and transmitting an instruction to transport, by a vehicle, the shipping equipment desired to be provided in accordance with the information indicating the carry-in place and the carry-in time to a manager of the vehicle.

Aspects of the present disclosure may include an information processing apparatus and a recording medium including a program recorded thereon that have the same features as the information processing method. Aspects of the present disclosure may include an information processing system including an information processing apparatus, and a terminal of a supplier and a terminal of a manager of a vehicle that are each connected to the information processing apparatus via a network and may include each of the terminals that perform communication in the information processing system.

According to the present disclosure, it is possible to ship a shipping object at a right time in response to a demand.

### BRIEF DESCRIPTION OF THE DRAWINGS

FIG. 1 is a schematic diagram of an information processing system according to an embodiment;

FIG. 2 illustrates an example of a configuration of a server;

FIG. 3 illustrates an example of a configuration of a terminal apparatus which can be used as each of terminals illustrated in FIG. 1;

FIG. 4 is a sequence chart illustrating an example of operation of the information processing system;

FIG. 5A illustrates an example of a format of a message as demand information, and FIG. 5B illustrates an example of a format of a message as shipping invitation information;

FIG. 6A illustrates an example of a format of a message as application information, and FIG. 6B illustrates an example of a format of a message as supply information;

FIG. 7A illustrates an example of a format of a message as a request for shipping for a supplier, and FIG. 7B illustrates an example of a format of a message as an equipment carry-in instruction;

FIG. 8 is a flowchart illustrating an example of a process by a processor of the server;

FIG. 9 illustrates an example of a data structure of a correspondence table;

FIG. 10 is a flowchart illustrating an example of a process by a processor of a terminal of a supplier; and

FIG. 11 is a sequence chart illustrating a modification example of the embodiment.

### DESCRIPTION OF THE EMBODIMENTS

An information processing method according to an embodiment may include performing, by an information processing apparatus, the following:

(1) transmitting demand information including a quantity demanded and a shipping deadline for an agricultural and marine product as a shipping object and shipping support information including information indicating shipping equipment that is capable of being provided in regard to shipping of the shipping object to a supplier;
(2) acquiring information indicating shipping equipment that is desired to be provided and information indicating a carry-in place and a carry-in time for the shipping equipment desired to be provided from a supplier that performs shipping object supply appropriate to the demand information; and
(3) transmitting an instruction to transport, by a vehicle, the shipping equipment desired to be provided in accordance with the information indicating the carry-in place and the carry-in time to a manager of the vehicle.

A supplier of agricultural and marine products (e.g., a producer of agricultural and marine products) may simply bring harvested products to a shipping destination (collection destination) in advance and may not have shipping equipment. Although a supplier may have a shipping destination other than a principal shipping destination, a quantity supplied to the shipping destination may be small. A supplier may not have a machine (e.g., a precut vegetable manufacturing apparatus) which processes a harvested product and may not be able to deal with various shipping forms.

According to the information processing method, demand information including a quantity demanded and a shipping deadline for an agricultural and marine product as a shipping object and shipping support information including information indicating shipping equipment that is capable of being provided in regard to shipping of the shipping object are transmitted to a supplier, which allows the supplier to judge whether to perform shipment in response to a demand while referring to the information on the shipping equipment capable of being provided. The supplier that performs shipping object supply appropriate to the demand information transmits information indicating shipping equipment that is desired to be provided and information indicating a carry-in place and a carry-in time for the shipping equipment desired to be provided to an information processing apparatus. The information processing apparatus transmits an instruction to transport, by a vehicle, the shipping equipment desired to be provided in accordance with the information indicating the carry-in place and the carry-in time to a manager of the vehicle. Upon receipt of the instruction, the manager carries the shipping equipment into the carry-in place, and the supplier can make preparations for shipping using the shipping equipment and perform shipping at a right time in time for the shipping deadline. That is, a supplier can obtain demand information, and convert surplus agricultural and marine products into a shipping form appropriate to a demand using provided shipping equipment and ship the agricultural and marine products in a case where shipping of all products to a regular shipping destination may cause a price collapse.

Here, suppliers of agricultural and marine products are producers of the agricultural and marine products and include, for example, farmers, stock farmers, fishers, aquafarmers, and the like. The term “harvested product” in the present specification refers not only to a plant but also to an animal which is obtained by capture, breeding, aquiculture, or the like. Agricultural and marine products as shipping objects include agricultural products and marine products. Agricultural products include cereals, vegetables, fruits, beans, flowers, stock farm products, and the like. Stock farm products include meat, organs, milk, eggs, fat, leather, and the like. Marine products include seafood, seaweeds, and the like. Agricultural and marine products are preferably food products but may be products other than food products. The degree to which a food product has undergone processing does not matter. Food products include fresh food products and processed food products.

Pieces of shipping equipment include machines (including a tool) which are made available for shipping work. Machines include a sorting machine which sorts a shipping object by, e.g., size or weight, a washing machine, a processing machine, a wrapping machine, and the like. Note that types of pieces of shipping equipment (machines) are not limited to the above-described ones.

Provision of shipping equipment refers to loan or rental, or transfer of the shipping equipment. As a provision form for shipping equipment, a machine as the shipping equipment may be made to be provided (loaned or rented, or transferred) alone or a mobile facility including the machine arranged therein may be provided. The mobile facility may be one which is loaded on or pulled by a vehicle, or an in-vehicle space of a vehicle may be used as a facility (workplace). A vehicle may be separable into a portion (an upper portion) as a mobile facility and a portion (a lower portion) including a self-propelled mechanism, and shipping equipment may be made to be provided by putting the separated portion as the mobile facility in a shipping place.

A vehicle which transports shipping equipment may be a dedicated vehicle or a general-purpose vehicle. The general-purpose vehicle is a vehicle for transport purpose, such as a truck or a trailer. The dedicated vehicle may be one having a loading platform on which shipping equipment is loaded. The dedicated vehicle may be a vehicle including a vertically separable mechanism which is separated into a portion (a lower portion) including a self-propelled mechanism and a mobile facility portion (an upper portion), as described above. The vehicle may be one which a driver drives or one which runs by itself through autonomous driving.

A shipping place is a place, such as a farm (e.g., a paddy, a field, a hydroponic farm, a dairy farm, a pasture, and a livestock farm), a fishing port, or an aquafarm, into which agricultural and marine products (harvested products) as a shipping object are collected and in which work for shipping is performed. The work for shipping includes sorting by, e.g., size, washing, processing (e.g., cutting, heating, sterilization, and production of a processed food product made from a harvested product), and wrapping (e.g., boxing, bagging, and binding). Processed food products include precut vegetables, precut fruit, dairy products (e.g., butter), dried marine products, canned products, bottled products, and the like.

Demand information and shipping support information may be transmitted to suppliers at one time or may be individually transmitted to suppliers. The demand information may further include information indicating a shipping form for a shipping object, and the shipping support information may include information indicating shipping equipment corresponding to the shipping form for the shipping object. This allows a supplier to deal with various shipping forms.

Alternatively, the information processing method may adopt a configuration which, when information wishing to use a vehicle to transport a shipping object to a shipping destination is acquired from a supplier which performs shipping object supply appropriate to demand information, transmits an instruction to transport the shipping object to the shipping destination using the vehicle to a manager of the vehicle. This makes it possible to transport a shipping object to a shipping destination using a transport vehicle for shipping equipment when a supplier does not have means for transport to the shipping destination or cannot afford transport.

Alternatively, the information processing method may adopt a configuration which, when shipping support information includes information giving guidance in dispatch of a staff member (an assistant) who supports the work of shipping a shipping object, and information wishing for dispatch of a staff member is acquired from a supplier which performs shipping object supply appropriate to demand information, transmits information giving an instruction to dispatch a staff member to a manager of the staff member. This allows smooth shipping work. A staff member is preferably a manipulator of shipping equipment which is desired to be provided. In this case, the supplier can efficiently use the shipping equipment even if the supplier is not experienced in manipulation of the shipping equipment.

Alternatively, in the information processing method, information indicating shipping equipment may include information for selecting between provision of the shipping equipment alone and provision of a mobile facility including the shipping equipment. When a supplier has a workplace with a wide roof, the supplier may desire provision of the shipping equipment alone. When there is a place but there is no roof, and there is no building to house the shipping equipment either, the supplier may desire provision of the mobile facility.

An information processing method, an information processing apparatus, and a processor according to an embodiment will be described below with reference to the drawings. A configuration according to the embodiment is illustrative only, and the present disclosure is not limited to the configuration according to the embodiment.

### System Configuration

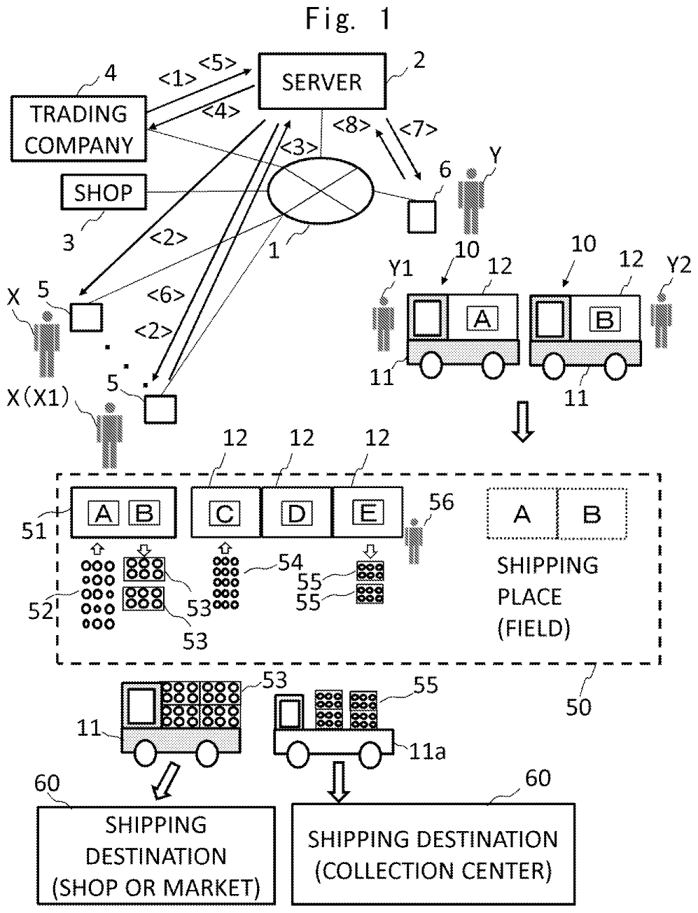

FIG. 1 is a schematic diagram of an information processing system according to the embodiment. The information processing system is a system which supports supplied product shipping appropriate to a demand. Referring to FIG. 1, the information processing system includes a network 1, and a server 2 and terminals 3, 4, 5, and 6 which are connected to the network 1.

The network 1 is, for example, a public telecommunication network, such as the Internet, and can adopt a WAN (Wide Area Network) or any other communication network. The network 1 may include a cellular network, such as LTE (Long Term Evolution), and a wireless network (wireless path), such as a wireless LAN (Local Area Network) (including Wi-Fi (registered trademark)).

The server 2 is an example of an “information processing apparatus”. The server 2 performs a process of supporting shipping appropriate to a demand through communication with each of the terminals 3 to 6. The terminals 3 to 6 each have a communication function. The terminal 3 is a terminal of a shop which sells food products, and the terminal 4 is a terminal of a trading company. The shop and the trading company are examples of a “demander”.

Each of the terminals 3 and 4 transmits demand information for harvested products to the server 2. The server 2 distributes the demand information to the terminal 5 that is managed by each of one or more suppliers (e.g., harvested product producers) X. The terminal 5 of the supplier X that responds to a demand indicated by the demand information transmits a response to the demand information to the server 2. The response includes information indicating a quantity supplied for the supplier X and information calling for loan or rental of shipping equipment needed to ship the quantity supplied by a shipping deadline.

When the server 2 embraces the response, the server 2 sends an instruction to transport the shipping equipment to a shipping place to the terminal 6 of a manager Y of the shipping equipment. The manager Y directs a vehicle 11 which is loaded with the shipping equipment that is called upon to be provided (e.g., loaned or rented) toward a shipping place 50 in accordance with the instruction. With this configuration, when the supplier X does not have shipping equipment which converts harvested products into a shipping form designated in demand information or the supplier X has small-sized shipping equipment, the supplier can be loaned or rented shipping equipment and ship the harvested products by a due date (shipping deadline).

### Configuration of Server

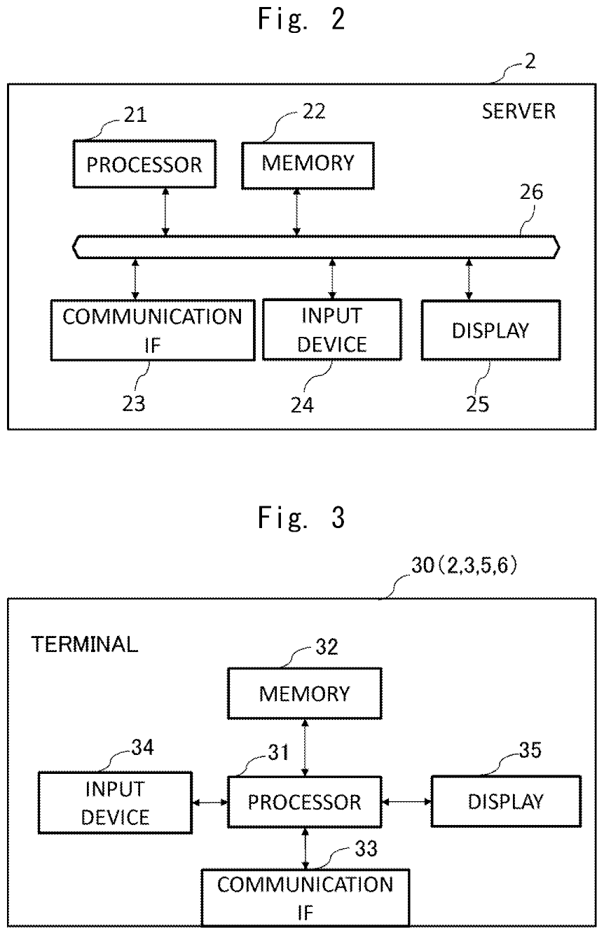

FIG. 2 illustrates an example of a configuration of the server 2. The server 2 can be constructed using a general-purpose information processing apparatus (computer), such as a personal computer (PC) or a workstation, or a dedicated information processing apparatus, such as a server machine. The server 2 has a communication function and can be connected to the network 1 by wire or by radio.

The server 2 includes a processor 21 as a processor, a memory 22, a communication interface (communication IF) 23, an input device 24, and a display 25 which are connected to one another via a bus 26. The server 2 may be one information processing apparatus or a collection (cloud) of two or more information processing apparatuses.

The memory 22 includes a main memory and an auxiliary memory. The main memory is used as a storage region for a program and data, a program development region, a program work region, a buffer region for communication data, and the like. The main memory is constructed as a RAM (Random Access Memory) or a combination of a RAM and a ROM (Read Only Memory). The auxiliary memory is used as a storage region for data and a program. The auxiliary memory includes, for example, a nonvolatile storage medium, such as a hard disk, an SSD (Solid State Drive), a flash memory, or an EEPRCM (Electrically Erasable Programmable Read-Only Memory).

The communication IF 23 is a circuit which performs communication processing. For example, the communication IF 23 is a network interface card (NIC). The communication IF 23 may be a circuit which performs wireless communication (through, e.g., LTE or a wireless LAN (Wi-Fi (registered trademark)) or an NIC and wireless communication circuit.

The input device 24 includes keys, buttons, a pointing device, a touch panel, and the like and is used to input information. The display 25 is, for example, a liquid crystal display and displays information and data.

The processor 21 is, for example, a CPU (Central Processing Unit). The processor 21 performs various processes by executing various types of programs stored in the memory 22.

For example, the processor 21 performs a process of receiving various pieces of demand information through communication with the terminals 3 and 4 of the demanders. The processor 21 also receives supply information through communication with the terminal 5 of the supplier. The supply information may be one which is issued in response to demand information or one which is issued as information indicating a suppliable quantity in a situation where no concrete demand is clear. That is, the processor 21 may perform a process of distributing demand information to one or more terminals 5 and receiving supply information as a response to the demand information. Alternatively, the processor 21 may receive pieces of demand information and pieces of supply information and perform a process of matching the pieces of supply information with the pieces of demand information.

The processor 21 also performs a process of accepting a call for loan or rental of shipping equipment from the terminal 5. The call for loan or rental may be included in supply information, may be transmitted at the same time as supply information at a given time, or may be transmitted at a time different from a transmission time for supply information. When the call for loan or rental is embraced, the processor 21 transmits an instruction (a carry-in instruction) to carry the shipping equipment into a shipping place toward the terminal 6 of the manager of the shipping equipment.

### Configuration of Terminal

FIG. 3 illustrates an example of a configuration of a terminal apparatus 30 which can be used as each of the terminals 3 to 6 illustrated in FIG. 1. The terminal apparatus 30 may be, for example, a laptop personal computer or a smart device, such as a smartphone or a tablet terminal. Alternatively, the terminal apparatus 30 may be a mobile terminal (a communication terminal with portability), such as a Personal Digital Assistant (PDA) or a wearable computer. Note that the terminal apparatus 30 may be a fixed terminal or a mobile terminal. Alternatively, the terminal apparatus 30 may be a wireless terminal or a wired terminal. The terminal apparatus 30 may be a general-purpose information processing apparatus or a dedicated information processing apparatus. The terminal apparatus 30 as the terminal 6 may be a wireless terminal which is carried and is brought into a vehicle (loaded into the vehicle) by a driver of the vehicle or a wireless terminal (car-mounted terminal) which is installed on a vehicle.

The terminal apparatus 30 includes a processor 31, a memory 32, a communication interface (communication IF) 33, an input device 34, and a display 35. As each of the processor 31, the memory 32, the communication IF 33, the input device 34, and the display 35, the same ones as those described for the processor 21, the memory 22, the communication IF 23, the input device 24, and the display 25 can be used. Note that one which is distinct in performance from the one used in the server 2 is used in accordance with a difference in purpose or intended use. The processor 31 causes the terminal apparatus 30 to operate as each of the terminals 3 to 6 by executing various types of programs stored in the memory 32.

Note that a plurality of CPUs or a multi-core CPU may be used as each of the processor 21 and the processor 31. At least a part of processing to be performed by a CPU may be executed by a processor other than a CPU, such as a DSP (Digital Signal Processor) or a GPU (Graphical Processing Unit). Also, at least a part of processing to be performed by a CPU may be executed by a dedicated or general-purpose integrated circuit, such as an ASIC (Application Specific Integrated Circuit) or an FPGA (Field Programmable Gate Array), or a combination of a processor and an integrated circuit. The combination of the processor and the integrated circuit is called, for example, a microcontroller (MCU), an SoC (System-on-a-Chip), a system LSI, a chip set, or the like. A part of processing to be performed by the processor 21 may be made to be performed by the processor 31.

### Operation Example

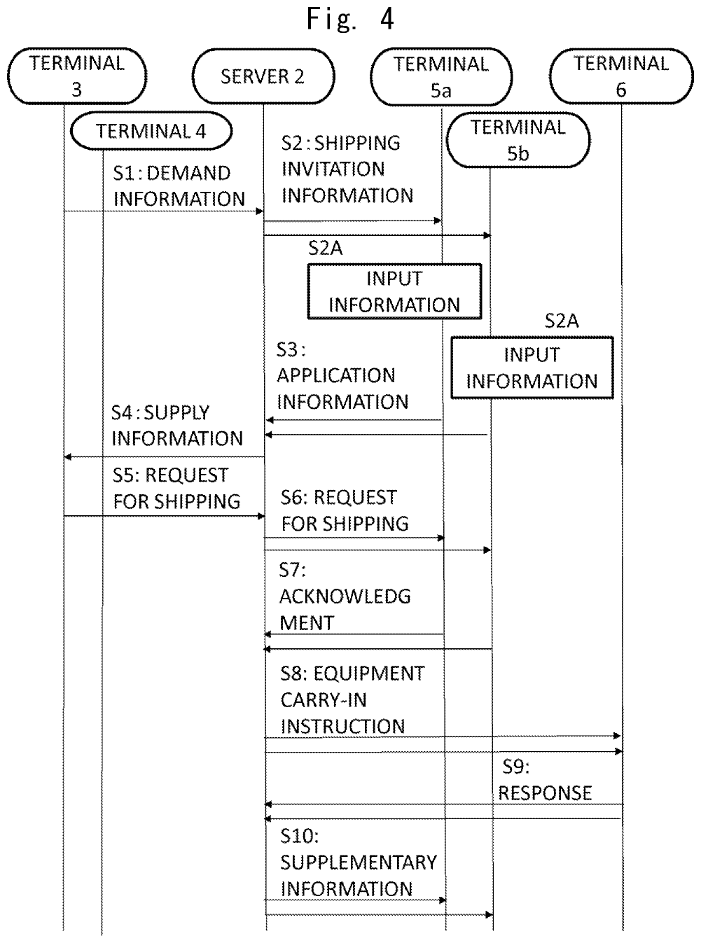

An example of operation in the information processing system will be described below. FIG. 4 is a sequence chart illustrating the example of the operation of the information processing system.

A terminal (see FIG. 1) (the terminal 3 is illustrated as an example in FIG. 4) of a demander, such as the terminal 3 or 4, transmits a message as demand information for particular agricultural and marine products to the server 2 (step S1). The terminals 3 and 4 know in advance a network address of the server 2. An example where the terminal 3 transmits demand information to the server 2 will be described with reference to FIG. 4. The same processing and operation are also performed in a case where the terminal 4 transmits demand information.

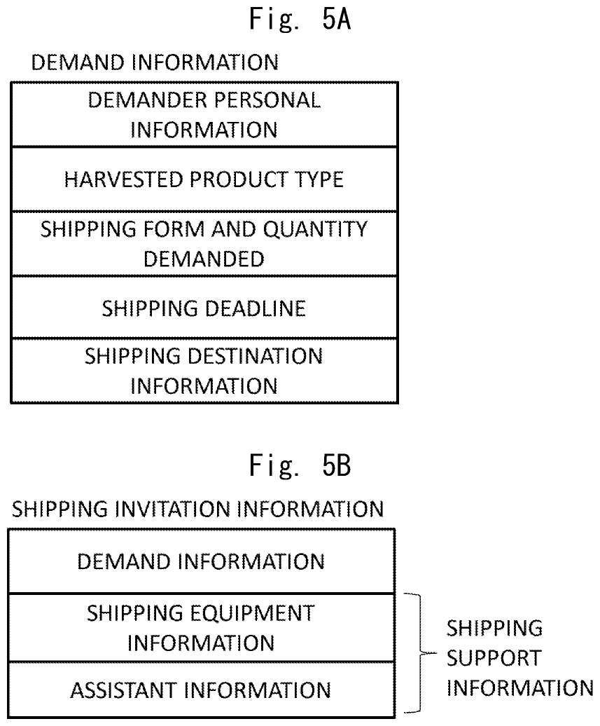

FIG. 5A illustrates an example of a format of a message as demand information. The demand information includes demander personal information, a harvested product type, a shipping form and a quantity demanded, a unit price, a shipping deadline, shipping destination information, and the like. The demander personal information includes a name, an ID, contact information, and the like of a demander. The shipping form indicates the status of harvested products at the time of shipping and indicates whether the harvested products are processed, the degree to which the harvested products are processed, and the status (e.g., boxed, bagged, bottled, precut, or processed into processed food products) of harvested products when transported to a shipping destination. The quantity demanded is expressed in a predetermined unit (e.g., the number of pieces or (a weight)×(the number of cases)). The unit price indicates a purchase amount per predetermined unit. When supply from two or more suppliers is accepted, a minimum supply quantity per supplier expressed in a predetermined unit is presented together with the quantity demanded (e.g., the quantity demanded is ten cases, and the minimum supply quantity is two cases). The shipping destination information indicates a transmission destination for a shipping object (shipped products) in the shipping form. The shipping destination is a sales store (e.g., a shop or a market) for the shipping object, a collection center (a collection place for packages to be transported over a long distance), or the like.

The server 2 after reception of the demand information generates a message as shipping invitation information including some or all of information elements (information items) constituting the demand information and distributes the shipping invitation information to the terminals 5 of suppliers (step S2). In FIG. 4, two terminals which are a terminal 5a of supplier 1 and a terminal 5b of supplier 2 are illustrated as examples of a plurality of terminals 5. Note that the number of terminals 5 depends on the number of suppliers and may be one or three or more. The terminals 5a and 5b each receive the message as the shipping invitation information. The distribution may be performed by transmitting, by the server 2, the message as the shipping invitation information to a network address of the already-known terminal 5 or may be performed by transmitting the message as the shipping invitation information to the terminal 5 accessing the server 2.

FIG. 5B illustrates an example of a format of a message as shipping invitation information. The shipping invitation information includes demand information and shipping support information. The demand information in the shipping invitation information may be the whole of demand information received from the terminal 3 or 4 or a part of demand information which is obtained by extracting a predetermined information element from the received demand information by a predetermined rule.

The shipping support information includes shipping equipment information and assistant information. The shipping equipment information includes information indicating the type, the size, the performance, the number of pieces which can be loaned or rented, an installation condition (e.g., the size of a space) for the shipping equipment, accessories (e.g., a packaging material), a fee, and the like of shipping equipment which can be loaned or rented (possibly transferred) to a supplier. The shipping equipment information also includes information for selecting between provision of shipping equipment alone and provision of a mobile facility including shipping equipment. The assistant information includes information inquiring about dispatch of a staff member (an assistant) who supports shipping work, such as an operator of a machine as shipping equipment and an assistant in work other than machine manipulation, and information indicating a dispatch fee. Note that the assistant information is optional and may not be included in the shipping support information.

The user of the terminal 5 (each of the terminals 5a and 5b) after the reception of the shipping invitation information inputs predetermined information to the terminal 5 (step S2A). That is, the terminal 5 displays demand information and shipping equipment information included in the shipping invitation information on the display 35. The supplier refers to the type of, a shipping form for, and a quantity demanded for a shipping object in the demand information displayed on the display 35 and determines whether to supply.

A supplier may be able to secure or prepare harvested products which meet a quantity demanded but may be unable to perform shipping that meets the quantity demanded by a deadline, depending on the type, the number, the performance, and the size of pieces of shipping equipment. A supplier may not have a machine which performs packaging or wrapping, or processing appropriate to a shipping form designated in demand information, and may be able to prepare harvested products but may be unable to perform shipping in the designated shipping form. Under the above-described situations, a supplier refers to shipping support information included in shipping invitation information. The supplier can judge whether to respond to an invitation by being loaned or rented shipping equipment and trying at least one of increasing a quantity supplied and dealing with the designated shipping form.

When the supplier responds to the invitation after consideration, the supplier inputs a quantity shipped (quantity supplied) for the shipping object to the terminal 5 using the input device 34. When the supplier is loaned or rented shipping equipment, the supplier determines the type and the number of pieces of shipping equipment which are desired to be loaned or rented, position information of a shipping place (carry-in place) where the pieces of shipping equipment are to be installed, and a time (carry-in time) at which the pieces of shipping equipment are to be carried in to the shipping place, and inputs information indicating these items to the terminal 5 using the input device 34.

Additionally, when the supplier wishes for support for transport of the shipping object to a shipping destination, the supplier inputs desire-for-transport information desiring transport to the terminal 5 using the input device 34. When the supplier desires dispatch of a staff member who assists in shipping work, i.e., an assistant, the supplier can input, to the terminal 5, desire-for-assistant information, i.e., the number and the role (e.g., machine manipulation or work assistance other than machine manipulation) of staff members who are desired to be dispatched.

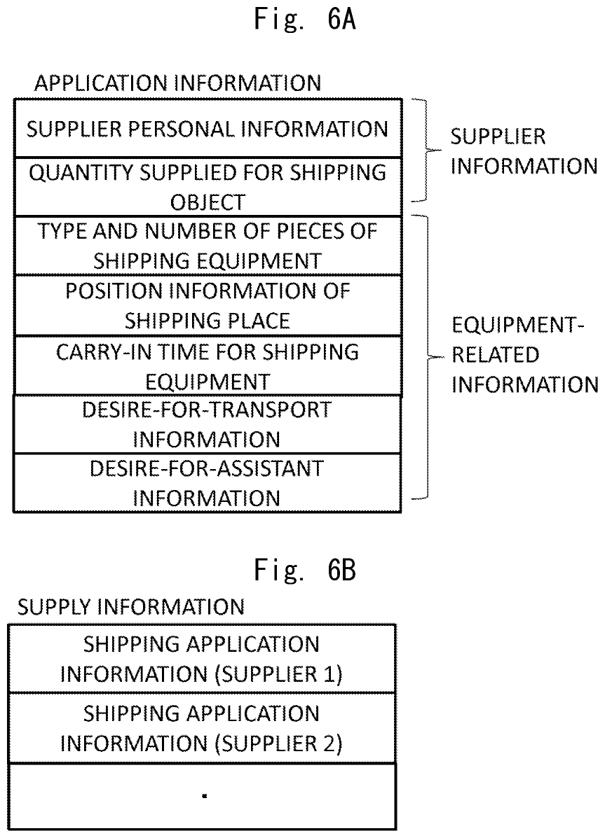

The terminal 5 generates application information using the input information. FIG. 6A illustrates an example of a format of a message as application information. The application information includes supplier information. The supplier information includes personal information (e.g., a name, an ID, and contact information) of a supplier and a quantity supplied for a shipping object. When the supplier is loaned or rented shipping equipment, the application information includes equipment-related information based on information input by the supplier. The equipment-related information includes the type and the number of pieces of shipping equipment desired to be provided, a provision form (alone or with a facility) for the pieces of shipping equipment, position information of a shipping place, a carry-in time for the pieces of shipping equipment, desire-for-transport information, and desire-for-assistant information. Note that input of the desire-for-transport information and the desire-for-assistant information is optional and that these pieces of information are not included in the message when there is no input.

The terminal 5 transmits the generated message as the application information to a source address of the shipping invitation information (step S3). In FIG. 4, messages as pieces of application information are transmitted from each of the terminals 5a and 5b to the server 2.

The server 2 after reception of the pieces of application information from each of the terminals 5a and 5b generates and transmits a message as supply information (step S4) when the sum of quantities supplied in the pieces of application information satisfies the quantity demanded in the demand information. Note that transmission of application information is optional and that application information may be transmitted from only one of the terminals 5a and 5b. When the application information from one of the terminals 5a and 5b satisfies the whole of the quantity demanded, a reply to the effect that the invitation is ended is sent to a transmission source of the later application information.

FIG. 6B illustrates an example of a format of a message as supply information. The supply information includes pieces of supplier information in pieces of application information received from each supplier. The message as the supply information is transmitted to a terminal (the terminal 3 in FIG. 4) as a transmission source of the demand information.

The terminal 3 after reception of the message as the supply information displays the content of the supply information on the display 35 of the terminal 3. The demander confirms the content of the supply information and inputs, via the input device 34, information with intent to request shipping in response to pieces of shipping application information from each supplier (with intent to approve the pieces of shipping application information). Upon receipt of the information with intent to make a request, the processor 31 of the terminal 3 transmits a message as a request for shipping to the server 2 (step S5).

Upon receipt of the message as the request for shipping from the terminal 3, the server 2 generates a message as a request for shipping (with intent to accept the application information) for each supplier and transmits the message to the terminal 5 (each of the terminals 5a and 5b) (step S6).

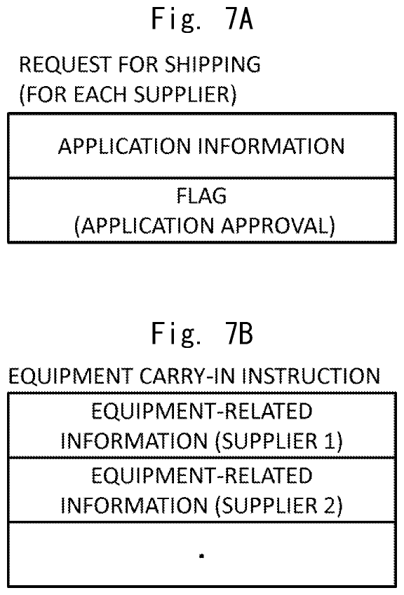

FIG. 7A illustrates an example of a format of a message as a request for shipping for a supplier (the terminal 5). The request for shipping includes application information and a flag (an identifier) indicating that an application is approved. When a message as application information received from the terminal 5 has an application information message ID attached thereto, the application information message ID may be included in a message as a request for shipping instead of the application information.

Note that steps S4 and S5 may be omitted and that, when it is judged in the server 2 that a quantity supplied satisfies a quantity demanded, a message as a request for shipping may be made to be transmitted toward each supplier.

Upon receipt of the message as the request for shipping, the terminal 5 (each of the terminals 5a and 5b) generates and transmits a message as an acknowledgment of the request for shipping (step S7). The acknowledgment is received by the server 2.

Upon receipt of an acknowledgment, the server 2 transmits a message as an equipment carry-in instruction to the terminal 6 of a manager of a vehicle which transports shipping equipment (step S8). FIG. 7B illustrates an example of a format of a message as an equipment carry-in instruction. The equipment carry-in instruction includes pieces of equipment-related information (FIG. 6A) obtained from each supplier.

A user (which is, for example, a driver of the vehicle but may be a person other than a driver) of the terminal 6 receives each equipment carry-in instruction and transmits a response message indicating that the equipment carry-in instruction is accepted to the server 2 (step S9). The manager conveys the equipment carry-in instructions to the driver of the vehicle, and the driver transports each designated piece of shipping equipment in a designated provision form to a shipping place in time for a carry-in time.

The server 2 after reception of the response message transmits, to the terminal 5 (each of the terminals 5a and 5b), information including a notification with intent to loan or rent shipping equipment in accordance with a desire and a necessary supplement (step S10).

An application example will be described with reference to FIG. 1. For example, a message as demand information is transmitted from the terminal 4 of the trading company to the server 2 (<1> in FIG. 1). The server 2 distributes a message as shipping invitation information to the terminal 5 of each supplier (<2> in FIG. 1). Assume that, as for a fruit (e.g., an orange) which is an example of an agricultural and marine product (an agricultural and marine product which is a food product) as a shipping object, a quantity demanded (a first demand) for oranges for which a shipping form is such that oranges of “predetermined size (e.g., large size) are boxed”, and a quantity demanded (a second demand) for oranges for which a shipping form is such that oranges are “cut in predetermined shapes”, are included in the demand information together with respective shipping deadlines. Note that the demand information may include a demand for at least one shipping form.

A supplier X1 which is one of suppliers is an orange producer, owns an orange grove, and can harvest oranges which satisfy the first and second demands from the orange grove. On the other hand, the supplier X1 uses the orange grove as the shipping place 50 where shipping work is to be performed and performs the work of shipping oranges. The shipping place 50 has a facility 51 (a building) for shipping work, and a sorting machine A as a machine which sorts harvested oranges 52 by size and a packaging machine B which boxes oranges sorted by size are installed as pieces of shipping equipment in the facility 51. However, there is insufficient time for the sorting machine A and the packaging machine B owned by the supplier X1 to perform shipping appropriate to the first demand by the deadline. The supplier X1 does not have shipping equipment for shipping oranges in a shipping form appropriate to the second demand.

The supplier X1 inputs supplier information which responds to all of the first and second demands to the terminal 5. The supplier X1 also inputs, to the terminal 5, equipment-related information calling for loan or rental of the sorting machine A and the packaging machine B for responding to the first demand, a desire for loan or rental (i.e., provision) of machines (e.g., a washing machine C, a cutting machine D, and a packing machine E for packing into a predetermined container) for responding to the second demand, and dispatch of an assistant. The terminal 5 transmits application information including the input supplier information and equipment-related information to the server 2 (<3> in FIG. 1).

When the application information satisfies all of the first and second demands, the server 2 transmits supply information to the terminal 4 (<4> in FIG. 1) and receives a request for shipping (<5> in FIG. 1). Upon the receipt of the request for shipping from the terminal 4, the server 2 generates a request for shipping for the terminal 5 and transmits the request for shipping to the terminal 5 of the supplier X1 (<6> in FIG. 1).

The server 2 transmits an equipment transport instruction to the terminal 6 of the manager Y of the vehicles 11 for transport of shipping equipment (<7> in FIG. 1). The manager Y after reception of the equipment transport instruction sends, in reply, a responsive instruction to the server 2 (<8> in FIG. 1). The manager Y conveys, to drivers Y1 and Y2 of the vehicles 11, position information of the shipping place 50 (the orange grove) of the supplier X1 and a carry-in time, and instructs the drivers Y1 and Y2 to transport pieces of shipping equipment. The manager Y itself may serve as a driver.

In the operation example illustrated in FIG. 1, the washing machine C, the cutting machine D, and the packing machine E are already transported to the shipping place 50. On the other hand, FIG. 1 also illustrates how the driver Y1 transports the sorting machine A and how the driver Y2 transports the packaging machine B. Shipping equipment (each of the machines A to E) to be loaned or rented is provided in a mobile building 12, and the building 12 is loaded on the vehicle 11 and transported by the vehicle 11. The building 12 is unloaded at a predetermined position of the shipping place 50 and is used as a workplace (mobile facility) where shipping work is performed using the shipping equipment in the building 12. Alternatively, shipping equipment may be put in the vehicle 11, and the vehicle 11 may be used as a workplace. In this case, the vehicle 11 stops at the predetermined position of the shipping place 50 and is used as a facility.

In FIG. 1, the buildings 12 including the washing machine C, the cutting machine D, and the packing machine E, respectively, are arranged at predetermined positions of the shipping place 50 and are used as a factory to manufacture precut fruit (processed products) appropriate to the second demand. For example, as a result of sorting in the sorting machine A, oranges of large size are packed into a box 53. Oranges 54 of a size other than large size are brought into a manufacturing place for precut fruit, and a case 55 containing a plurality of processed products, each packed in a predetermined container, is manufactured in the manufacturing place.

Note that, as for the building 12, a plurality of buildings 12 may be configured to be coupled so as to form one wide workspace. Alternatively, a configuration in which the building 12 is a part of the vehicle 11, the building 12 is separated from the vehicle 11 at the shipping place 50, and the building 12 is put at a predetermined position of the shipping place 50 may be adopted. In FIG. 1, an assistant 56 which supports load carriage, machine manipulation, and the like is dispatched to the shipping place 50. The assistant 56 may be dispatched to the shipping place 50 by the vehicle 11 or may be dispatched to the shipping place 50 by a different method. A driver of the vehicle 11 may double as the assistant 56.

The demand information includes information indicating respective shipping destinations for the box 53 and the case 55 containing oranges, and the box 53 and the case 55 are transported to designated shipping destinations 60. The transport may be performed using the vehicle 11 or may be performed using a vehicle 11a (e.g., a vehicle of the supplier X1) other than the vehicle 11. When equipment-related information including desire-for-transport information (FIG. 6A) is included in the equipment carry-in instruction, the vehicle 11 is used for transport. In this case, the manager Y gives an instruction regarding a quantity loaded on the vehicle 11, where a shipping destination is located, a transport deadline (shipping deadline) for the shipping destination, and the like to a driver in accordance with the equipment carry-in instruction. An example where the box 53 is delivered to the shipping destination 60 (a shop or a market), and the case 55 is delivered to the shipping destination 60 (a collection center for packages to be loaded on a long-distance truck) is illustrated in FIG. 1. Note that the box 53 may be brought into the collection center, and the case 55 may be brought into the shop or the market. As long as a quantity demanded for a demander is satisfied, oranges in the box 53 or the case 55 may be sold in a shipping place or may be shipped to somewhere other than a shipping destination designated by the demander.

As described above, even a supplier which does not have equipment which can respond to a demand or a supplier which does not have shipping equipment appropriate to a shipping form can be loaned or rented shipping equipment (and furthermore be provided with the dispatched assistant 56), to perform shipping appropriate to the demand.

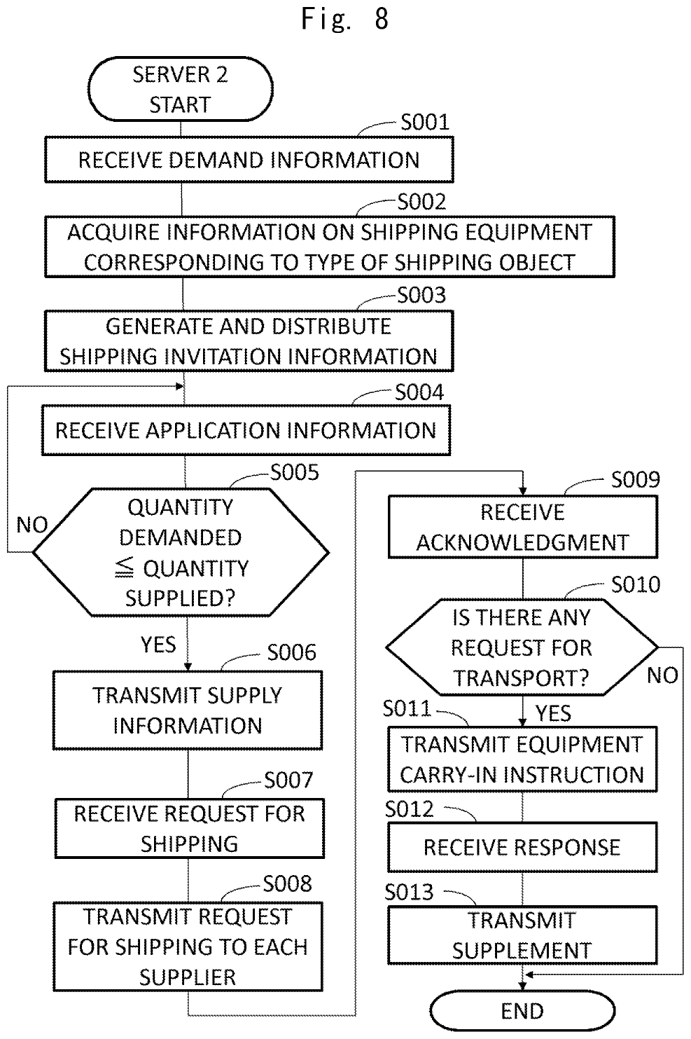

FIG. 8 is a flowchart illustrating an example of a process by the processor 21 of the server 2. In step S001, the processor 21 receives demand information from the terminal 3 or 4 which is received through the communication IF 23 and stores the demand information in the memory 22.

In step S002, the processor 21 acquires information on shipping equipment corresponding to the type and the shipping form of a shipping object in the demand information. Here, the memory 22 stores a correspondence table among shipping object (harvested product) types, shipping forms, and pieces of shipping equipment.

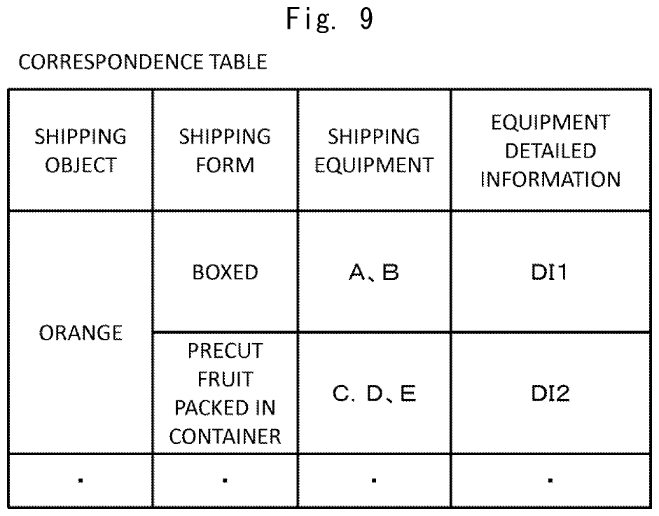

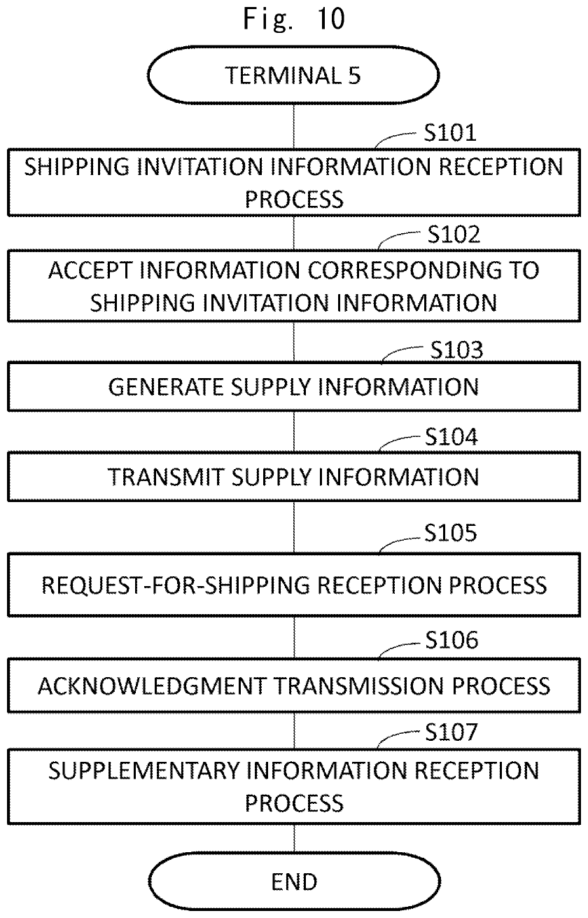

FIG. 9 illustrates an example of a data structure of the correspondence table. The correspondence table stores shipping equipment and detailed information thereon corresponding to a shipping object and a shipping form. In the example illustrated in FIG. 9, the sorting machine A and the packaging machine B as pieces of shipping equipment corresponding to “ORANGE” as a shipping object and “BOXED” as a shipping form, and detailed information on the machines are registered. Also, the machines C, D, and E as pieces of shipping equipment corresponding to “ORANGE” as a shipping object and “PRECUT FRUIT PACKED IN CONTAINER” as a shipping form, and detailed information on the machines are registered.

The processor 21 acquires, from the correspondence table, the information indicating the shipping equipment corresponding to the shipping object and the shipping form and detailed information on the shipping equipment. Note that a configuration in which the correspondence table is managed by a machine other than the memory 22 outside the server 2, and corresponding information is sent in reply when the shipping object and the shipping form are transmitted to the outside machine may be adopted.

In step S003, the processor 21 generates a message as shipping invitation information including the demand information acquired in step S001 and the information on the shipping equipment acquired in step S002. The processor 21 also transmits the message as the shipping invitation information to network addresses of the terminals 5 of suppliers which are registered in the server 2. Note that distribution may be a voluntary operation of performing distribution to a network address of the already registered terminal 5 or a passive operation of sending, in reply, a message as shipping invitation information to the terminal 5 accessing the server 2.

In step S004, the processor 21 receives messages as pieces of application information from the terminals 5 which have received the shipping invitation information. In step S005, the processor 21 calculates the sum of quantities supplied in the pieces of application information and judges whether the sum is equal to or more than a quantity demanded in the demand information. With the judgement in step S005, it is judged whether the quantities supplied from the plurality of suppliers satisfy the quantity demanded indicated by the demand information. When demand information is distributed to two or more terminals 5, when the sum of quantities supplied sent in reply from each of the terminals 5 becomes equal to or more than a quantity demanded, acceptance of application information corresponding to the demand information is ended.

In step S006, the processor 21 performs a process of generating and transmitting a message (see FIG. 6B) as supply information. A message ID (already received by the server 2 in S001) of the demand information is attached to the message as the supply information. The message as the supply information is transmitted to the terminal 3 or 4 as a transmission source of the demand information via the communication IF 23.

In step S007, the processor 21 performs a process of receiving a message as a request for shipping corresponding to the supply information from the terminal 3 or 4. The message as the request for shipping includes, for example, the message ID of the demand information and information (a flag) with intent to approve the application information.

In step S008, the processor 21 generates messages (FIG. 7A) as requests for shipping for the respective suppliers and transmits the messages to the terminals 5 as transmission sources of the pieces of application information. Note that steps S006 and S007 may be omitted and that, when a judgement of YES is made in step S005, the process in step S008 may be made to be performed.

In step S009, the processor 21 receives messages as acknowledgments from the terminals 5. In step S010, the processor 21 judges whether equipment-related information is included in the application information in the request for shipping, for which the acknowledgment is obtained. When it is judged that the pieces of application information do not include equipment-related information, a call for loan or rental of shipping equipment is considered as absent, and the process in FIG. 8 ends.

When it is judged that the pieces of application information includes equipment-related information, the processor 21 generates a message (FIG. 7B) as an equipment carry-in instruction and transmits the message to the terminal 6, and advances the process to step S012.

In step S012, the processor 21 receives a response corresponding to the equipment carry-in instruction, and transmits a message including supplementary information to the terminal 5 (step S013) when there is a supplementary matter for the supplier. When step S013 ends, the process in FIG. 8 ends.

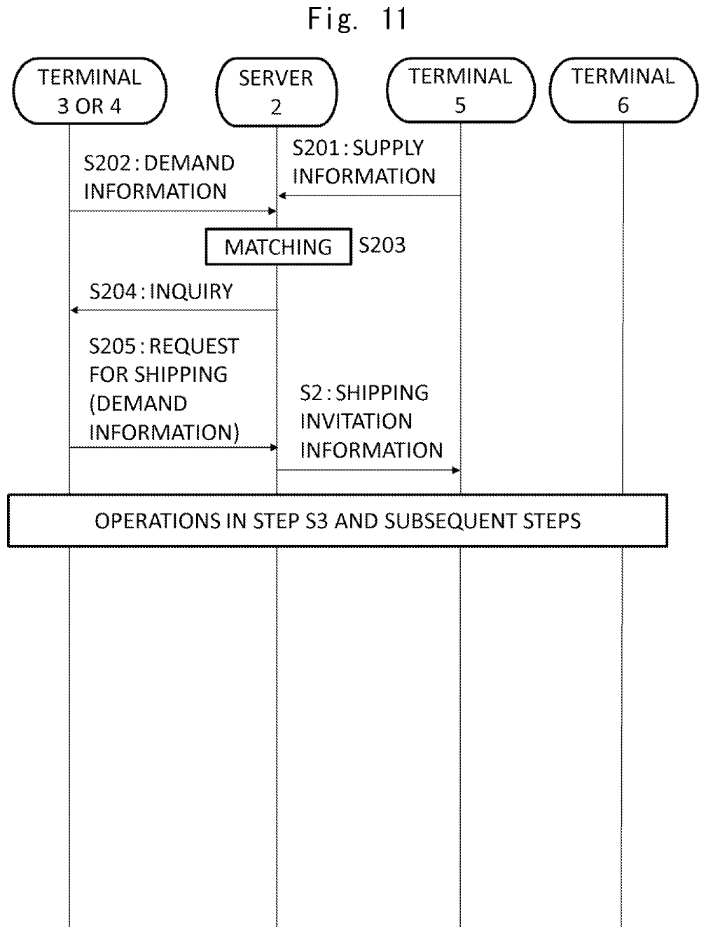

FIG. 10 is a flowchart illustrating an example of a process by the processor 31 of the terminal 5. In step S101, the processor 31 performs a process of receiving shipping invitation information which is received through the communication IF 33.

In step S102, the processor 31 accepts supplier information which is input using the input device 34 on the basis of the shipping invitation information. When equipment-related information is input, the equipment-related information is also accepted. Absence of input of equipment-related information or input of a notification to the effect that there is no equipment-related information means that a supplier is not loaned or rented shipping equipment.

In step S103, the processor 31 uses the input information to generate a message as supply information including at least the supplier information and transmits the message to the server 2 (step S104).

In step S105, the processor 31 performs a process of receiving a message (FIG. 7A) as a request for shipping from the server 2. The processor 31 displays the application information corresponding to the request for shipping on the display 35. When the supplier refers to the application information, and inputs a notification with intent to approve the request for shipping using the input device 34, the processor 31 generates a message as an acknowledgment and transmits the message to the server 2 (step S106). An acknowledgment is a declaration with intent to perform supply appropriate to demand information and is a call for loan or rental of shipping equipment which meets equipment-related information (and furthermore may include at least one of a call for transport of a shipped product and a call for dispatch of an assistant).

Step S107 is a process which is executed as an option in a case where the application information includes equipment-related information (a case where the supplier calls for, e.g., loan or rental of shipping equipment) and performs a process of receiving supplementary information which is transmitted from the server 2. A supplier receives supplementary information as information indicating that loan or rental of shipping equipment or the like is approved. Also, cautions on, e.g., loan or rental of shipping equipment which are included in the supplementary information can be received.

### Effects of Embodiment

According to the embodiment, a supplier can be provided with shipping equipment and perform shipping of a quantity which meets a demand from a demander by a shipping deadline. That is, it is possible to ship a shipping object in a quantity appropriate to a demand at a right time. The supplier can also deal with various shipping forms by being supplied with shipping equipment. As described above, the supplier can add and select a shipping destination for agricultural and marine products as a shipping object upon receipt of shipping invitation information from a server. A demander can establish a network with new suppliers through distribution of demand information to a plurality of suppliers via the server 2.

### Modification Examples

In the above-described embodiment, processing starts when each of the terminals 3 and 4 transmits demand information to the server 2. Note that the server 2 may be made to distribute a quantity supplied for a supplier to a demander, the demander may send demand information, and that the supplier may respond to the demand information. For example, an operation as illustrated in FIG. 11 may be performed. The server 2 receives supply information which is transmitted from the terminal 5 (step S201), and receives pieces of demand information which are transmitted from the terminals 3 and 4 (step S202). Either may be received first.

The server 2 matches the pieces of demand information with the supply information (step S203). That is, the server 2 finds a demand which meets the type and the suppliable quantity of a shipping object which can be supplied by a supplier.

When the supply information satisfies a part or the whole of a demand indicated by one of the pieces of demand information in the matching, the server 2 transmits an inquiry message inquiring whether to request shipping from the supplier as a transmission source of the supply information to the terminal 3 or 4 as a demand source (step S204). When the terminal 3 or 4 as the demand source responds to the inquiry, the terminal 3 or 4 transmits a message as a request for shipping requesting supply of the shipping object type and the quantity supplied included in the inquiry message to the server 2. The request for shipping corresponds to a message as demand information transmitted in step S1 in FIG. 4. The same operations (operations in step S2 and the subsequent steps) as a case where the server 2 receives a message as demand information in FIG. 4 are performed. As described above, the server 2 may receive supply information before demand information.

Note that, unlike the embodiment, a vehicle housing a wrapping (boxing or bagging) machine which is shipping equipment may be made to perform wrapping work while moving to a shipping destination. The building 12 can also be used as a direct sales depot facility which sells shipped products in the shipping place 50.

### Others

The above-described embodiment is merely illustrative, and the present disclosure can be properly changed and carried out without departing from the scope thereof.

A process described as being performed by one apparatus may be shared and executed by a plurality of apparatuses. Alternatively, a process described as being performed by different apparatuses may be executed by one apparatus. By which hardware configuration (server configuration) each of the functions are implemented in a computer system can be flexibly changed.

The present disclosure can also be implemented by supplying a computer program including the functions described in the above-described embodiment to a computer and reading out and executing the program by one or more processors of the computer. Such a computer program may be provided to the computer by a non-transitory computer-readable storage medium connectable to a system bus of the computer or may be provided to the computer via a network. Examples of the non-transitory computer-readable storage medium include any type of disk, such as a magnetic disk (e.g., a floppy (registered trademark) disk or a hard disk drive (HDD)) or an optical disc (e.g., a CD-ROM, a DVD, or a Blu-ray Disc), a read only memory (ROM), a random access memory (RAM), an EPROM, an EEPROM, a magnetic card, a flash memory, an optical card, and any type of medium suitable for storing electronic instructions.

What is claimed is:

1. An information processing method comprising:
transmitting demand information including a quantity demanded and a shipping deadline for an agricultural and marine product as a shipping object and shipping support information including information indicating shipping equipment that is capable of being provided in regard to shipping of the shipping object to a supplier;
acquiring information indicating shipping equipment that is desired to be provided and information indicating a carry-in place and a carry-in time for the shipping equipment desired to be provided from a supplier that performs shipping object supply appropriate to the demand information; and
transmitting an instruction to transport, by a vehicle, the shipping equipment desired to be provided in accordance with the information indicating the carry-in place and the carry-in time for the shipping equipment desired to be provided to a manager of the vehicle.

2. The information processing method according to claim 1, wherein
the demand information further includes information indicating a shipping form for the shipping object, and
the shipping support information includes information indicating shipping equipment corresponding to the shipping form for the shipping object.

3. The information processing method according to claim 1, wherein
when information wishing to use the vehicle to transport the shipping object to a shipping destination is acquired from the supplier that performs the shipping object supply appropriate to the demand information, an instruction to transport the shipping object to the shipping destination using the vehicle is transmitted to the manager of the vehicle.

4. The information processing method according to claim 1, wherein
the shipping support information includes information giving guidance in dispatch of a staff member who supports work of shipping the shipping object, and
when information wishing for dispatch of the staff member is acquired from the supplier that performs the shipping object supply appropriate to the demand information, information giving an instruction to dispatch the staff member is transmitted to a manager of the staff member.

5. The information processing method according to claim 4, wherein
the staff member is a manipulator of the shipping equipment desired to be provided.

6. The information processing method according to claim 1, wherein
the agricultural and marine product as the shipping object is a food product.

7. The information processing method according to claim 1, wherein
the shipping equipment includes at least one of a sorting machine, a washing machine, a processing machine, and a wrapping machine.

8. The information processing method according to claim 1, wherein
the information indicating the shipping equipment includes information for selecting between provision of the shipping equipment alone and provision of a mobile facility including the shipping equipment.

9. An information processing apparatus comprising
a processor configured to execute:
a process of transmitting demand information including a quantity demanded and a shipping deadline for an agricultural and marine product as a shipping object and shipping support information including information indicating shipping equipment that is capable of being provided in regard to shipping of the shipping object to a supplier;
a process of acquiring information indicating shipping equipment that is desired to be provided and information indicating a carry-in place and a carry-in time for the shipping equipment desired to be provided from a supplier that performs shipping object supply appropriate to the demand information; and
a process of transmitting an instruction to transport, by a vehicle, the shipping equipment desired to be provided in accordance with the information indicating the carry-in place and the carry-in time for the shipping equipment desired to be provided to a manager of the vehicle.

10. The information processing apparatus according to claim 9, wherein
the demand information further includes information indicating a shipping form for the shipping object, and
the shipping support information includes information indicating shipping equipment corresponding to the shipping form for the shipping object.

11. The information processing apparatus according to claim 9, wherein
when information wishing to use the vehicle to transport the shipping object to a shipping destination is acquired from the supplier that performs the shipping object supply appropriate to the demand information, the processor transmits an instruction to transport the shipping object to the shipping destination using the vehicle to the manager of the vehicle.

12. The information processing apparatus according to claim 9, wherein
the shipping support information includes information giving guidance in dispatch of a staff member who supports work of shipping the shipping object, and
when information wishing for dispatch of the staff member is acquired from the supplier that performs the shipping object supply appropriate to the demand information, the processor transmits information giving an instruction to dispatch the staff member to a manager of the staff member.

13. The information processing apparatus according to claim 12, wherein
the staff member is a manipulator of the shipping equipment desired to be provided.

14. The information processing apparatus according to claim 9, wherein
the agricultural and marine product as the shipping object is a food product.

15. The information processing apparatus according to claim 9, wherein
the shipping equipment includes at least one of a sorting machine, a washing machine, a processing machine, and a wrapping machine.

16. The information processing apparatus according to claim 9, wherein
the information indicating the shipping equipment includes information for selecting between provision of the shipping equipment alone and provision of a mobile facility including the shipping equipment.

17. A non-transitory storage medium storing a program that causes a computer of an information processing apparatus to execute:
a process of transmitting demand information including a quantity demanded and a shipping deadline for an agricultural and marine product as a shipping object and shipping support information including information indicating shipping equipment that is capable of being provided in regard to shipping of the shipping object to a supplier;
a process of acquiring information indicating shipping equipment that is desired to be provided and information indicating a carry-in place and a carry-in time for the shipping equipment desired to be provided from a supplier that performs shipping object supply appropriate to the demand information; and
a process of transmitting an instruction to transport, by a vehicle, the shipping equipment desired to be provided in accordance with the information indicating the carry-in place and the carry-in time for the shipping equipment desired to be provided to a manager of the vehicle.

18. The non-transitory storage medium storing the program according to claim 17, wherein
the demand information further includes information indicating a shipping form for the shipping object, and
the shipping support information includes information indicating shipping equipment corresponding to the shipping form for the shipping object.

19. The non-transitory storage medium storing the program according to claim 17, wherein
when information wishing to use the vehicle that transports the shipping equipment desired to be provided to transport the shipping object to a shipping destination is acquired, the program causes the computer to execute a process of transmitting the instruction including a transport instruction to transport the shipping object to the shipping destination using the vehicle to the manager of the vehicle.

20. The non-transitory storage medium storing the program according to claim 17, wherein
the shipping support information includes information giving guidance in dispatch of a staff member who supports work of shipping the shipping object, and
when information wishing for dispatch of the staff member is acquired from the supplier, the program causes the computer to execute a process of transmitting information giving an instruction to dispatch the staff member to a manager of the staff member.
